(19) United States
(12) Patent Application Publication
(10) Pub. No.: US 2009/0279797 A1
(43) Pub. Date: Nov. 12, 2009

(54) ENTROPY ENCODING AND DECODING METHOD AND APPARATUS USING LEAST SIGNIFICANT BIT

(75) Inventors: Jong-bum CHOI, Suwon-si (KR); Woo-sung SHIM, Suwon-si (KR); Sung-bum PARK, Seongnam-si (KR); Young-ho MOON, Suwon-si (KR); Dai-Woong CHOI, Seoul (KR); Jae-won YOON, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/426,593

(22) Filed: Apr. 20, 2009

(30) Foreign Application Priority Data
May 9, 2008 (KR) 10-2008-0043320

(51) Int. Cl. G06K 9/36

(52) U.S. Cl. 382/233; 382/248

(57) ABSTRACT

Provided are entropy encoding and decoding methods. The entropy encoding method includes receiving residual coefficients obtained by frequency converting a residual image, determining a first bit string about residual coefficients having nonzero levels from among the received residual coefficients, determining at least one lower bit, including a least significant bit of the first bit string, from the first bit string, and determining a second bit string obtained by bit-shifting the first bit string to the right by the number of lower bits.

### CROSS-REFERENCE TO RELATED PATENT APPLICATION

This application claims priority from Korean Patent Application No. 10-2008-0043320, filed on May 9, 2008, in the Korean Intellectual Property Office, the disclosure of which is incorporated herein in its entirety by reference.

### BACKGROUND OF THE INVENTION

1. Field of the Invention

The present invention relates to entropy encoding and decoding, and more particularly, to entropy encoding and decoding a frequency converted coefficient of a residual image.

2. Description of the Related Art

Various current image compressing techniques including H.264 perform frequency conversion on an image, and binarization on a frequency converted coefficient by using an entropy encoding technique.

FIG. 1 is a flowchart illustrating a context-based adaptive binary arithmetic code (CABAC) method for a residual coefficient in a block unit.

For entropy encoding in H.264, in operation 100, CABAC is performed on the residual coefficient in a block unit. In operation 110 (coded_block_flag), it is determined whether a nonzero residual coefficient exists in the block unit, and when it is determined that the nonzero residual coefficient exists in the block, in operation 120 (coded_block_flag!=0), it is determined whether there is a significant coefficient from among the residual coefficients, in operation 130 (significant_coeff_flag[i] and last_significant_flag[i]). The significant coefficient denotes a coefficient having a nonzero level.

When it is determined that the significant coefficient exists among the residual coefficients, in operation 140 (significant_coeff_flag!=0), 1 is subtracted from an absolute value of a residual coefficient level, i.e., the significant coefficient in operation 150 (coeff_abs_level_minus1), and a sign of the residual coefficient level is checked in operation 160 (coeff_sign_flag[i]).

FIG. 2 is a comparison histogram of residual coefficients by lossy compression and lossless compression.

FIG. 2 illustrates histograms of residual coefficients obtained by performing motion prediction according to lossy compression (QP28 and QP32) and lossless compression on an experimental moving image in an 8 bit RGB form having a size of 512×512 and a title of ‘Airplane’.

In FIG. 2, a horizontal axis shows a residual coefficient level and a vertical axis shows the number of coefficients.

Residual coefficients generated via the lossy compression (QP28 and QP32) are distributed mainly in an area having a small residual coefficient level, but residual coefficients generated via the lossless compression have a large residual coefficient level deviation as compared to those generated via the lossy compression (QP28 and QP32), and thus are widely distributed.

In H.264, various techniques for effectively expressing a residual coefficient between images are designed to use few binary bits when a residual coefficient has a low level (0˜4), and use many binary bits when a residual coefficient has a high level. Accordingly, current residual coefficient expressing techniques are designed to satisfactorily use the characteristics of a residual coefficient generated via lossy compression where quantization is performed.

Hence, current residual coefficient expressing techniques using the H.264 image compressing standard do not take into consideration the characteristics of a residual coefficient generated via lossless compression where quantization is not performed, and thus are inefficient in expressing the residual coefficient of lossless compression.

### SUMMARY OF THE INVENTION

The present invention effectively provides entropy-encoding coefficients having a distribution of coefficients having a nonzero level, by using a least significant bit.

According to an aspect of the present invention, there is provided an entropy encoding method, including: receiving residual coefficients obtained by frequency converting a residual image; determining a first bit string about residual coefficients having nonzero levels from among the received residual coefficients; determining at least one lower bit, including the least significant bit of the first bit string, from the first bit string; and determining a second bit string obtained by bit-shifting the first bit string to the right by the number of the at least one lower bit.

The determining of the first bit string may include: scanning the residual coefficient; determining a significant coefficient bit indicating whether a level of a current residual coefficient is 0; and when the level is not 0, determining a significant coefficient remaining bit indicating whether there is a residual coefficient having a nonzero level from among residual coefficients at a scan location after that of the current residual coefficient.

The determining of the first bit string may include determining a bit string about residual coefficients having levels obtained by subtracting 1 from absolute values of the nonzero levels of the residual coefficients, as the first bit string.

The determining of the first bit string may include, when the received residual coefficient is classified in a block unit including a predetermined number of residual coefficients, determining a significant coefficient bit in the block, the significant coefficient bit indicating whether the block comprises a residual coefficient having a nonzero level.

In the determining of the second bit string, the second bit string may be expressed in a truncated unary code.

In the determining of the second bit string, the second bit string may be expressed in an unsigned Exponential Golomb code 0.

The entropy encoding method may further include, when the level of the current residual coefficient is not 0, continuously outputting the significant coefficient bit, the significant coefficient remaining bit, the at least one lower bit comprising the least significant bit of the first bit string, and the second bit string.

The entropy encoding method may further include determining a coefficient sign bit that indicates a sign of a level.

According to another aspect of the present invention, there is provided an entropy decoding method, including: receiving bit strings about residual coefficients obtained by frequency converting a residual image; extracting at least one lower bit including a least significant bit from a bit string about residual coefficients having nonzero levels, from among the received bit strings; and bit-shifting the bit string about residual coefficients having nonzero levels to the left by the number of the at least one lower bit.

The entropy decoding method may further include: extracting a coefficient sign bit, indicating a sign of a level of a residual coefficient, from the received bit strings; and adding 1 to the value of the bit-shifted bit string, and determining the residual coefficients based on the coefficient sign bit.

The receiving of the bit string may include: extracting a significant coefficient bit from the received bit strings, and determining whether a level of a current residual coefficient is 0 based on the significant coefficient bit; when it is determined that the level of the current residual coefficient is not 0, extracting a significant coefficient remaining bit from the received bit strings; and determining whether a residual coefficient having a nonzero level exists among residual coefficients at a scan location after that of the current residual coefficient, based on the significant coefficient remaining bit.

The receiving of the bit strings include, when the residual coefficients are classified in a block unit including a predetermined number of residual coefficients, extracting a significant coefficient bit, indicating whether the block includes a residual coefficient having a nonzero level, from the received bit strings.

The received bit string may be expressed in a truncated unary code.

The received bit string may be expressed in an unsigned Exponential Golomb code 0.

According to another aspect of the present invention, there is provided an entropy encoding apparatus including: a residual coefficient inputter which receives residual coefficients obtained by frequency converting a residual image; a first bit string determiner which determines a first bit string about residual coefficients having nonzero levels from among the received residual coefficients; a least significant bit determiner which determines at least one lower bit, comprising a least significant bit of the first bit string, from the first bit string; and a second bit string determiner which determines a second bit string obtained by bit-shifting the first bit string to the right by the number of the at least one lower bit.

The first bit string determiner may scan the residual coefficient and determine a significant coefficient bit indicating whether a level of a current residual coefficient is 0, and when the level is not 0, may determine a significant coefficient remaining bit indicating whether there is a residual coefficient having a nonzero level from among residual coefficients at a scan location after that of the current residual coefficient.

The first bit string determiner may determine a bit string about residual coefficients having levels obtained by subtracting 1 from absolute values of the nonzero levels of the residual coefficients, as the first bit string.

The first bit string determiner, when the received residual coefficient is classified in a block unit including a predetermined number of residual coefficients, may determine a significant coefficient bit in the block unit, which indicates whether the block includes a residual coefficient having a nonzero level.

The second bit string may be expressed in a truncated unary code.

The second bit string may be expressed in an unsigned Exponential Golomb code 0.

The entropy encoding apparatus may further include a code outputter, which, when the level of the current residual coefficient is not 0, continuously outputs the significant coefficient bit, the significant coefficient remaining bit, the at least one lower bit including the least significant bit of the first bit string, and the second bit string.

The entropy encoding apparatus may further include a coefficient sign bit determiner which determines a coefficient sign bit that indicates a sign of a level of a residual coefficient.

According to another aspect of the present invention, there is provided an entropy decoding apparatus including: a bit string receiver which receives bit strings about residual coefficients obtained by frequency converting a residual image; a least significant bit extractor which extracts at least one lower bit, including the least significant bit from a bit string about residual coefficients having nonzero levels, from among the received bit strings; and a bit shifter which bit-shifts the bit string about residual coefficients having nonzero levels to the left by the number of the at least one lower bit.

The entropy decoding apparatus may further include: a coefficient sign bit extractor which extracts a coefficient sign bit, indicating a sign of a level of a residual coefficient, from the received bit strings; and a residual coefficient determiner which adds 1 to the bit-shifted bit string, and determines the residual coefficients based on the coefficient sign bit.

The bit string receiver may extract a significant coefficient bit from the received bit strings, and determine whether a level of a current residual coefficient is 0 based on the significant coefficient bit, and when it is determined that the level of the current residual coefficient is not 0, may extract a significant coefficient remaining bit from the received bit strings, and determine whether a residual coefficient having a nonzero level exists among residual coefficients at a scan location after that of the current residual coefficient, based on the significant coefficient remaining bit.

The received bit string may be expressed in a truncated unary code.

The received bit string may be expressed in an unsigned Exponential Golomb code 0.

According to another aspect of the present invention, there is provided a computer readable recording medium having recorded thereon a program for executing the entropy encoding method of above.

According to another aspect of the present invention, there is provided a computer readable recording medium having recorded thereon a program for executing the entropy decoding method of above.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a context-based adaptive binary arithmetic code (CABAC) method for a residual coefficient in a block unit;

FIG. 2 is a comparison histogram of residual coefficients by lossy compression and lossless compression;

FIG. 3 is a block diagram illustrating an entropy encoding apparatus according to an exemplary embodiment of the present invention;

FIG. 4 is a block diagram illustrating an entropy decoding apparatus according to an exemplary embodiment of the present invention;

FIG. 5 is a flowchart illustrating an entropy encoding method applied to context-based adaptive binary arithmetic code (CABAC), according to an exemplary embodiment of the present invention;

FIG. 6 is a table for comparing output results of a conventional CABAC and an entropy encoding method, according to an exemplary embodiment of the present invention, applied to CABAC;

FIG. 7 is a flowchart illustrating an entropy encoding method according to an exemplary embodiment of the present invention; and

FIG. 8 is a flowchart illustrating an entropy decoding method according to an exemplary embodiment of the present invention.

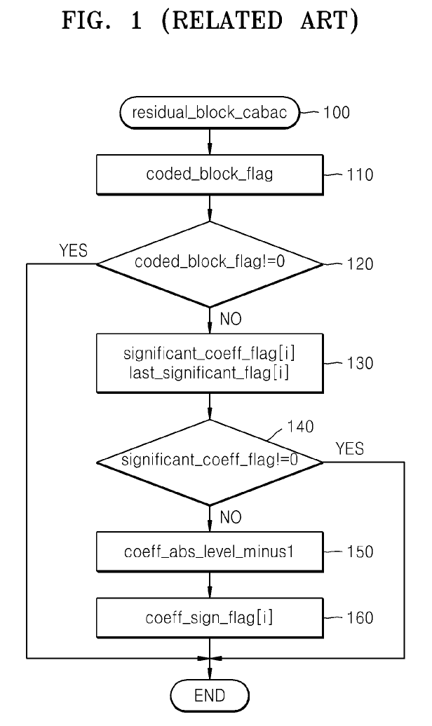

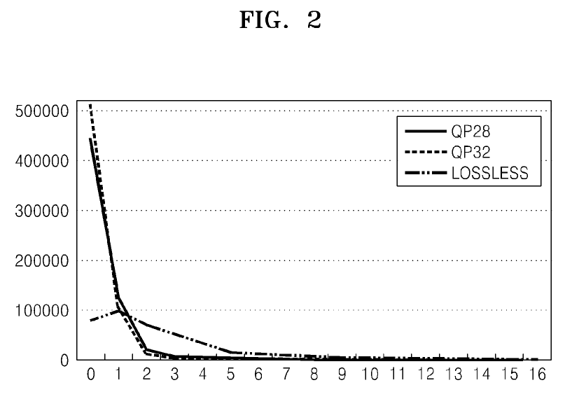

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

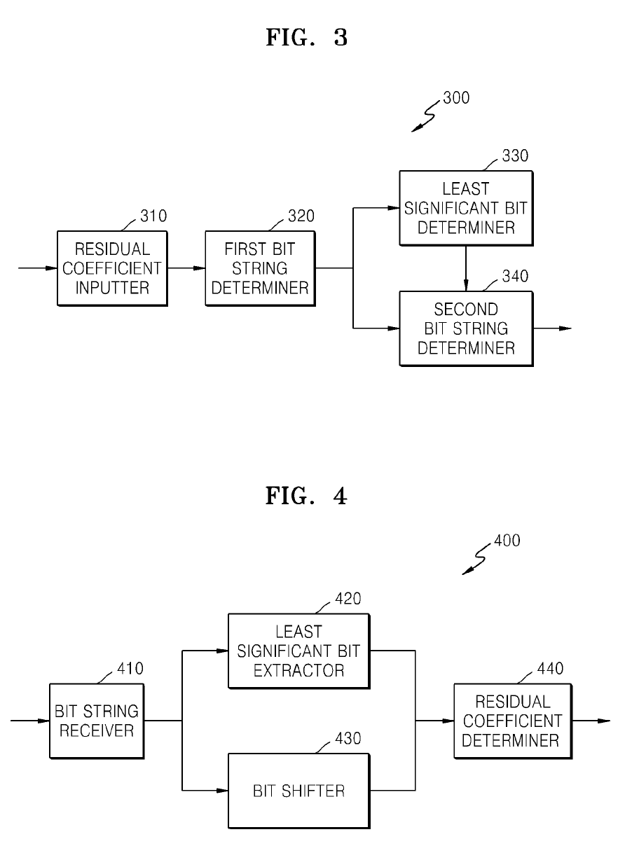

FIG. 3 is a block diagram illustrating an entropy encoding apparatus 300 according to an embodiment of the present invention.

The entropy encoding apparatus 300 includes a residual coefficient inputter 310, a first bit string determiner 320, a least significant bit determiner 330, and a second bit string determiner 340.

The residual coefficient inputter 310 receives residual coefficients obtained by frequency converting a residual image, and outputs the received residual coefficients to the first bit string determiner 320.

The first bit string determiner 320 determines a first bit string about residual coefficients having nonzero levels, from among the residual coefficients received from the residual coefficient inputter 310, and outputs the first bit string to the least significant bit determiner 330 and the second bit string determiner 340.

The first bit string determiner 320 may search for a significant coefficient in the residual coefficients by scanning the received residual coefficients. The first bit string determiner 320 may scan the received residual coefficients via a zigzag method. The significant coefficient denotes a coefficient having a nonzero level.

The first bit string determiner 320 may check a level of a current residual coefficient at a current scan location while sequentially scanning the received residual coefficients, and determine a significant coefficient bit, which indicates whether the level of the current residual coefficient is 0.

When the level of the current residual coefficient is not 0, the first bit string determiner 320 may check a level of a next residual coefficient in a scanning location next to the current scan location, and determine a significant coefficient remaining bit, which indicates whether there is a residual coefficient having a nonzero level.

The first bit string determiner 320 may determine a bit string about residual coefficients having levels obtained by subtracting 1 from absolute values of the nonzero levels of the residual coefficients, as the first bit string.

When the residual coefficients are processed in a block unit including a predetermined number of residual coefficients, the first bit string determiner 320 may check whether there is a residual coefficient having a nonzero level from among residual coefficients in the block unit, and determine a significant coefficient bit in the block unit, the significant coefficient bit indicating the result of checking.

The least significant bit determiner 330 receives the first bit string from the first bit string determiner 320, determines at least one lower bit including the least significant bit of the first bit string, and outputs the determined lower bit to the second bit string determiner 340.

Here, the ‘at least one lower bit’ may denote a single least significant bit, but may also denote lower bits having the lowest degrees and including the least significant bit.

The second bit string determiner 340 receives the first bit string from the first bit string determiner 320, receives the at least one lower bit from the least significant bit determiner 330, and then determines and outputs a second bit string obtained by bit-shifting the first bit string to the right by the number of lower bits determined by the least significant bit determiner 330.

In the current embodiment, the second bit string may be expressed in a truncated unary code. Alternatively, the second bit string may be expressed in a unsigned Exponential Golomb code 0.

The entropy encoding apparatus 300 may include a code outputter (not shown), which continuously outputs the significant coefficient bit, the at least one lower bit, and the second bit string. In other words, the code outputter may sequentially output the significant coefficient bit received from the first bit string determiner 320, the at least one lower bit of the first bit string received from the least significant bit determiner 330, and the second bit string received from the second bit string determiner 340. Also, when the levels of the residual coefficients are not 0, the code outputter may sequentially output the significant coefficient bit and the significant coefficient remaining bit received from the first bit string determiner 320.

Although not illustrated in FIG. 3, the entropy encoding apparatus 300 may further include a coefficient sign bit determiner, which determines a coefficient sign bit indicating a sign of a level of a residual coefficient.

FIG. 4 is a block diagram illustrating an entropy decoding apparatus 400 according to an embodiment of the present invention. The entropy decoding apparatus 400 can decode a signal encoded by the entropy encoding apparatus 300 described above with reference to FIG. 3.

The entropy decoding apparatus 400 includes a bit string receiver 410, a least significant bit extractor 420, a bit shifter 430, and a residual coefficient determiner 440.

The bit string receiver 410 receives a bit string about residual coefficients obtained by frequency converting a residual image, and outputs the received bit string to the least significant bit extractor 420 and the bit shifter 430.

The bit string receiver 410 may extract a significant coefficient bit from the received bit string, and determine whether a level of a current residual coefficient corresponding to the bit string is 0 based on the extracted significant coefficient bit. When the level of the current residual coefficient is not 0, the bit string receiver 410 may further extract a significant coefficient remaining bit from the received bit string, and determine whether a residual coefficient having a nonzero level exists among residual coefficients at a scan location after that of the current residual coefficient based on the significant coefficient remaining bit.

The received bit string may be expressed in a truncated unary code. Alternatively, the received bit string may be expressed in an unsigned Exponential Golomb code 0.

When the residual coefficients are classified in a block unit, the bit string receiver 410 may further extract a significant coefficient bit in the block unit, the significant coefficient bit indicating whether a residual coefficient having a nonzero level exists among residual coefficients inside the block unit.

Although not illustrated in FIG. 4, the entropy decoding apparatus 400 may further include a coefficient sign bit extractor (not shown), which extracts a coefficient sign bit that indicates a sign of a level of a residual coefficient, from the bit string received from the bit string receiver 410.

The least significant bit extractor 420 receives the bit string about residual coefficients having nonzero levels from the bit string receiver 410, and extracts at least one lower bit including the least significant bit of the bit string.

The bit shifter 430 receives a bit string about residual coefficients having nonzero levels from the bit string receiver 410, bit-shifts the bit string about residual coefficients having nonzero levels to the left by the number of lower bits determined by the least significant bit extractor 420, and outputs the bit-shifted bit string to the residual coefficient determiner 440.

The residual coefficient determiner 440 receives the at least one lower bit from the least significant bit extractor 420 and the bit-shifted bit string from the bit shifter 430, adds 1 to the value of the bit-shifted bit string, and then determines a residual coefficient about the currently received bit string based on at least one of the coefficient sign bit, the at least one lower bit, the significant coefficient bit, and the significant coefficient remaining bit.

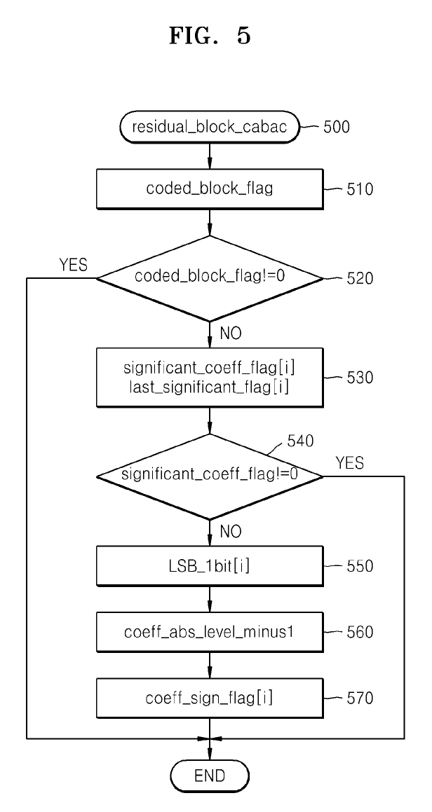

Hereinafter, an entropy encoding method and/or decoding method used in the entropy encoding apparatus 300 and the entropy decoding apparatus 400 will be described with reference to FIGS. 5 through 8.

FIG. 5 is a flowchart illustrating an entropy encoding method applied to a context-based adaptive binary arithmetic code (CABAC) method, according to an embodiment of the present invention.

The entropy encoding method, according to the current embodiment of the present invention, is applied to the CABAC entropy encoding method for a residual coefficient in a block unit in process 500.

In operation 510, the first bit string determiner 320 of the entropy encoding apparatus 300 determines a significant coefficient bit (coded_block_flag) in a block. The bit string receiver 410 of the entropy decoding apparatus 400 extracts the significant coefficient bit (coded_block_flag) from received residual coefficients, and determines whether a residual coefficient having a nonzero level exists in a block including a current residual coefficient based on the significant coefficient bit (coded_block_flag).

In FIG. 5, when the block does not include a residual coefficient having a nonzero level, the significant coefficient bit (coded_block_flag) is set to 0. Alternatively, if the block includes at least one residual coefficient having a nonzero level, the significant coefficient bit (coded_block_flag) is set to 1.

In operation 520, the first bit string determiner 320 of the entropy encoding apparatus 300 determines whether a level of the current residual coefficient is 0 based on the significant coefficient bit (coded_block_flag). When the significant coefficient bit (coded_block_flag) is 0, the entropy encoding method ends, and when the significant coefficient bit (coded_block_flag) is 1, the first bit string determiner 320 performs operation 530 so as to check a significant map.

The bit string receiver 410 of the entropy decoding apparatus 400 extracts the significant coefficient bit (coded_block_flag) from the received bit string, and determines whether a residual coefficient having a nonzero level exists in residual coefficients in the block including the current residual coefficient based on the significant coefficient bit (coded_block_flag) so as to determine whether there is a residual coefficient required to be analyzed because its level is not zero.

In operation 530, the first bit string determiner 320 of the entropy encoding apparatus 300 prepares a significant map about residual coefficients, and expresses information about residual coefficients having nonzero levels. The significant map includes information about a significant coefficient bit and a significant coefficient remaining bit. The bit string receiver 410 of the entropy decoding apparatus 400 may extract information about the significant bit map from the received bit string and check the information about residual coefficients having nonzero levels.

In FIG. 5, when a level of a current residual coefficient at a current scan location is 0, the significant coefficient bit (significant_coeff_flag) is set to 0. Alternatively, when the level of the current residual coefficient is not 0, the significant coefficient bit (significant_coeff_flag) is set to 1.

Also, when the level of the current residual coefficient is not 0, a significant coefficient remaining bit (last_significant_flag) is set for the current residual coefficient. According to an order of scanning residual coefficients in a block, when there is a residual coefficient having a nonzero level, from among residual coefficients in the scan location after that of the current residual coefficient having a nonzero level, the significant coefficient remaining bit (last_significant_flag) is set to 1, and when there are no more residual coefficients having a nonzero level, the significant coefficient remaining bit (last_significant_flag) is set to 0.

In operation 540, the first bit string determiner 320 of the entropy encoding apparatus 300 advances a first bit string about residual coefficients having nonzero levels to operation 550 to determine at least one lower bit based on the significant coefficient bit (significant_coeff_flag). When the levels of the residual coefficients are 0, the entropy encoding method is stopped.

The first bit string may be a binary code of a level obtained by subtracting 1 from an absolute value of the level of the current residual coefficient having a nonzero level.

In operation 550, the least significant bit determiner 330 of the entropy encoding apparatus 300 determines the at least one lower bit of the first bit string. Here, the at least one lower bit may be a single least significant bit, but may also be lower bits having the lowest degrees and including the least significant bit. In operation 550 (LSB_{—1}bit[i]), the number of the lower bit is 1, and the least significant bit determiner 330 determines the single least significant bit.

The least significant bit extractor 420 of the entropy decoding apparatus 400 extracts the at least one lower bit from the bit string about residual coefficients having nonzero levels. Here, the number of the extracted lower bits is determined based on the number of lower bits determined by the entropy encoding apparatus 300.

In operation 560, the second bit string determiner 340 of the entropy encoding apparatus 300 determines a bit string obtained by bit-shifting the first bit string to the right by the number of lower bits as a second bit string (coeff_abs_level_minus1). Also, the bit shifter 430 of the entropy decoding apparatus 400 bit-shifts a bit string, corresponding to the second bit string, to the left by the number of lower bits, and inserts the least significant bit to the right of the bit-shifted bit string.

In operation 570, the entropy encoding apparatus 300 may set a coefficient sign bit (coeff_sign_flag) indicating a sign of a level of a residual coefficient. Also, the residual coefficient determiner 440 of the entropy decoding apparatus 400 may extract the coefficient sign bit (coeff_sign_flag) from the received bit string, and finally determine a sign of a level of a residual coefficient.

For example, when a level of a residual coefficient is a positive number, the coefficient sign bit (coeff_sign_flag) is set to 0, and when the level is a negative number the coefficient sign bit (coeff_sign_flag) is set to 1.

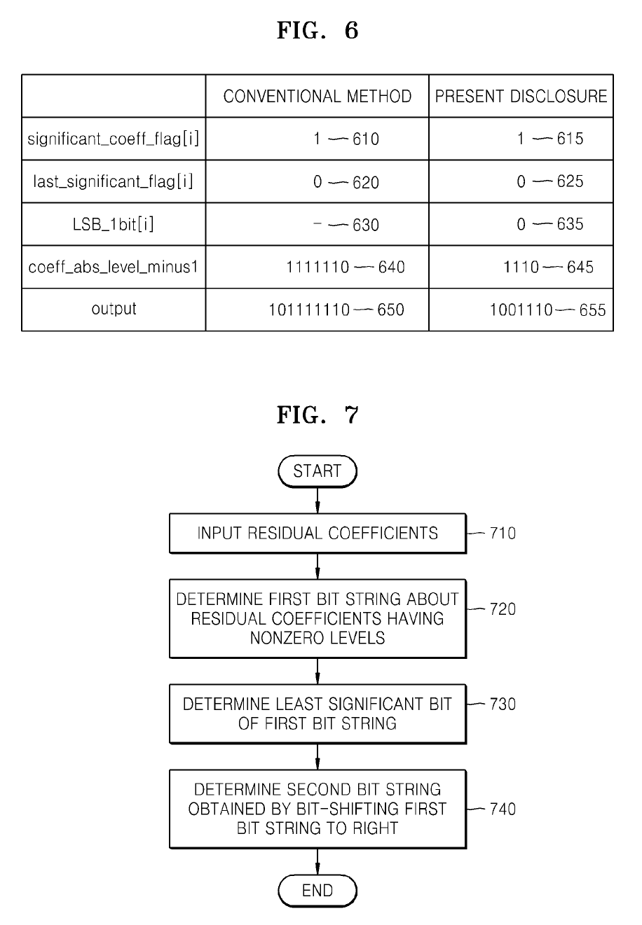

FIG. 6 is a table for comparing output results of a conventional CABAC and an entropy encoding method, according to an embodiment of the present invention, applied to CABAC.

In the table, a coefficient level of a bit string of FIG. 6 is 7, and the results of encoding a current residual coefficient instead of the last significant coefficient are illustrated. Since the coefficient level is not 0, a significant coefficient bit (significant_coeff_flag) is 1 both in a conventional method and the present disclosure.

Also, since the current residual coefficient is not the last significant coefficient, significant coefficient remaining bits (last_significant_flag) are all determined to be 0.

As a level of the current residual coefficient is 7, when 1 is subtracted from the absolute value of the level, the result is 6.

Unlike the conventional method, the present disclosure generates a first bit string by binarizing a value obtained by subtracting 1 from the absolute value of a level of a residual coefficient. In the case illustrated in FIG. 6, the first bit string is 110₍₂₎, and thus the least significant bit (LSB_{—}1bit) of the first bit string is determined to be 0.

When the value obtained by subtracting 1 from the absolute value of the level of the current residual coefficient is expressed in a truncated unary code according to a conventional method, a bit string (coeff_abs_level_minus1) about the levels of the residual coefficients is 1111110_{(TU)}.

Alternatively in an exemplary embodiment of the present invention, a second bit string (coeff_abs_level_minus1) obtained by bit-shifting the first bit string to the right by the number of the least significant bit is expressed in a truncated unary code. In other words, the first bit string is 110₍₂₎, and when the first bit string is bit-shifted to the right by the number of the least significant bit, i.e., 1, it becomes 11₍2)=3. When the second bit string is expressed in a truncated unary code, it is 1110_{(TU)}.

Accordingly, when the significant coefficient bit (significant_coeff_flag), the significant coefficient remaining bit(last_significant_flag), the least significant bit (LSB_{—1}bit) (only in the present disclosure), and the bit string about the levels of the residual coefficients (coeff_abs_level_minus1) are sequentially outputted according to the conventional method and the present disclosure, the result in the conventional invention is 101111110 and the result in the present invention is 1001110. Thus, the level of the same residual coefficient can be expressed with a smaller number of bits in the present invention than the conventional invention.

The entropy encoding and decoding described above with reference to FIGS. 5 and 6 are performed according to the H.264 standard or the CABAC method, but encoding and decoding using at least one lower bit including the least significant bit according to the present invention are not limited to the embodiments of FIGS. 5 and 6.

FIG. 7 is a flowchart illustrating an entropy encoding method according to an embodiment of the present invention.

In operation 710, residual coefficients obtained by frequency converting a residual image are inputted. The residual coefficients may be classified in a block unit.

In operation 720, a first bit string about residual coefficients having nonzero levels is determined. A significant coefficient bit and a significant coefficient remaining bit, which indicate information about a residual coefficient that is a significant coefficient, may be determined, and a significant coefficient bit in the block unit may be determined. A bit string about residual coefficients having levels obtained by subtracting 1 from absolute values of residual coefficients having nonzero levels may be determined as the first bit string.

In operation 730, at least one lower bit including the least significant bit of the first bit string is determined. The at least one lower bit may include only the single least significant bit, or lower bits having the lowest degrees and including the least significant bit.

In operation 740, a second bit string is determined by bit-shifting the first bit string to the right by the number of lower bits. The second bit string may be expressed in a truncated unary code or an unsigned Exponential Golomb code 0.

The significant coefficient bit, the significant coefficient remaining bit, the significant coefficient bit, the at least one lower bit, the second bit string, and a coefficient sign bit generated in each operation may be sequentially outputted and encoded.

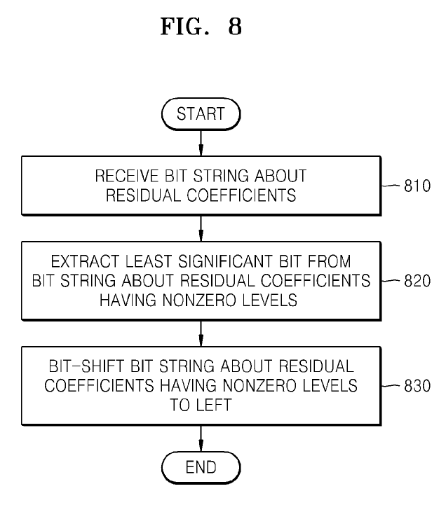

FIG. 8 is a flowchart illustrating an entropy decoding method according to an embodiment of the present invention.

In operation 810, a bit string about residual coefficients obtained by frequency converting a residual image is obtained. The received bit string may be expressed in a truncated unary code or an unsigned Exponential Golomb code 0. A significant coefficient bit, a significant coefficient remaining bit, and a significant coefficient bit in a block, which indicate information about a residual coefficient that is a significant coefficient, may be extracted from the received bit string.

In operation 820, at least one lower bit including the least significant bit of a bit string about residual coefficients having nonzero levels is extracted from the bit string about residual coefficients having nonzero levels.

In operation 830, the bit string about residual coefficients having nonzero levels is bit-shifted to the left by the number of lower bits from the received bit string. The lower bits are inserted to the right of the bit-shifted bit string, and then 1 is added to a value of the bit-shifted bit string. When a sign of a level of a residual coefficient is determined based on a coefficient sign bit, a residual coefficient about the received bit string can be finally determined.

The entropy encoding and decoding method according to the present disclosure can effectively perform entropy encoding on coefficients having several nonzero levels by dividing lower bits and bit-shifting the remaining bits. Accordingly, a residual coefficient in a lossless compression having a big deviation and an average can be expressed in a smaller number of bits as compared to a conventional method of expressing a residual coefficient.

Also, the entropy encoding and decoding method of the present disclosure can be applied to all techniques that are expressed in a bit string and entropy encoded, and is not limited to the CABAC method of the H.264 standard.

Embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

Embodiments of the present invention can also be written as computer programs and implemented in general-use digital computers that execute the programs using a computer readable transmission medium such as carrier waves (e.g., transmission through the Internet).

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An entropy encoding method, comprising:
receiving residual coefficients obtained by frequency converting a residual image;
determining a first bit string about residual coefficients having nonzero levels from among the received residual coefficients;
determining at least one lower bit, comprising the least significant bit of the first bit string, from the first bit string; and
determining a second bit string obtained by bit-shifting the first bit string to the right by the number of the at least one lower bit.

2. The entropy encoding method of claim 1, wherein the determining of the first bit string comprises:
scanning the residual coefficients;
determining a significant coefficient bit indicating whether a level of a current residual coefficient is 0; and
when the level is not 0, determining a significant coefficient remaining bit indicating whether there is a residual coefficient having a nonzero level from among residual coefficients at a scan location after that of the current residual coefficient.

3. The entropy encoding method of claim 1, wherein the determining of the first bit string comprises determining a bit string about residual coefficients having levels obtained by subtracting 1 from absolute values of the nonzero levels of the residual coefficients, as the first bit string.

4. The entropy encoding method of claim 1, wherein the determining of the first bit string comprises, when the received residual coefficient is classified in a block unit comprising a predetermined number of residual coefficients, determining a significant coefficient bit in the block, the significant coefficient bit indicating whether the block comprises a residual coefficient having a nonzero level.

5. The entropy encoding method of claim 1, wherein in the determining of the second bit string, the second bit string is expressed in a truncated unary code.

6. The entropy encoding method of claim 1, wherein in the determining of the second bit string, the second bit string is expressed in an unsigned Exponential Golomb code 0.

7. The entropy encoding method of claim 2, further comprising, when the level of the current residual coefficient is not 0, continuously outputting the significant coefficient bit, the significant coefficient remaining bit, the at least one lower bit comprising the least significant bit of the first bit string, and the second bit string.

8. The entropy encoding method of claim 1, further comprising determining a coefficient sign bit that indicates a sign of a level.

9. An entropy decoding method, comprising:
receiving bit strings about residual coefficients obtained by frequency converting a residual image;
extracting at least one lower bit comprising a least significant bit from a bit string about residual coefficients having nonzero levels, from among the received bit strings; and
bit-shifting the bit string about residual coefficients having nonzero levels to the left by the number of the at least one lower bit.

10. The entropy decoding method of claim 9, further comprising:
extracting a coefficient sign bit, indicating a sign of a level of a residual coefficient, from the received bit strings; and
adding 1 to a value of the bit-shifted bit string, and determining the residual coefficients based on the coefficient sign bit.

11. The entropy decoding method of claim 9, wherein the receiving of the bit string comprises:
extracting a significant coefficient bit from the received bit strings, and determining whether a level of a current residual coefficient is 0 based on the significant coefficient bit;
when it is determined that the level of the current residual coefficient is not 0, extracting a significant coefficient remaining bit from the received bit strings; and
determining whether a residual coefficient having a nonzero level exists among residual coefficients at a scan location after that of the current residual coefficient, based on the significant coefficient remaining bit.

12. The entropy decoding method of claim 8, wherein the receiving of the bit strings comprises, when the residual coefficients are classified in a block unit comprising a predetermined number of residual coefficients, extracting a significant coefficient bit, indicating whether the block comprises a residual coefficient having a nonzero level, from the received bit strings.

13. The entropy decoding method of claim 9, wherein the received bit strings are expressed in a truncated unary code.

14. The entropy decoding method of claim 9, wherein the received bit strings are expressed in an unsigned Exponential Golomb code 0.

15. An entropy encoding apparatus comprising:
a residual coefficient inputter which receives residual coefficients obtained by frequency converting a residual image;
a first bit string determiner which determines a first bit string about residual coefficients having nonzero levels from among the received residual coefficients;
a least significant bit determiner which determines at least one lower bit, comprising a least significant bit of the first bit string, from the first bit string; and
a second bit string determiner which determines a second bit string obtained by bit-shifting the first bit string to the right by the number of the at least one lower bit.

16. The entropy encoding apparatus of claim 15, wherein the first bit string determiner scans the residual coefficient and determines a significant coefficient bit indicating whether a level of a current residual coefficient is 0, and
when the level is not 0, determines a significant coefficient remaining bit indicating whether there is a residual coefficient having a nonzero level from among residual coefficients at a scan location after that of the current residual coefficient.

17. The entropy encoding apparatus of claim 15, wherein the first bit string determiner determines a bit string about residual coefficients having levels obtained by subtracting 1 from absolute values of the nonzero levels of the residual coefficients, as the first bit string.

18. The entropy encoding apparatus of claim 15, wherein the first bit string determiner, when the received residual coefficient is classified in a block unit comprising a predetermined number of residual coefficients, determines a significant coefficient bit in the block unit, which indicates whether the block comprises a residual coefficient having a nonzero level.

19. The entropy encoding apparatus of claim 15, wherein the second bit string is expressed in a truncated unary code.

20. The entropy encoding apparatus of claim 15, wherein the second bit string is expressed in an unsigned Exponential Golomb code 0.

21. The entropy encoding apparatus of claim 16, further comprising a code outputter, which, when the level of the current residual coefficient is not 0, continuously outputs the significant coefficient bit, the significant coefficient remaining bit, the at least one lower bit comprising the least significant bit of the first bit string, and the second bit string.

22. The entropy encoding apparatus of claim 15, further comprising a coefficient sign bit determiner which determines a coefficient sign bit that indicates a sign of a level of a residual coefficient.

23. An entropy decoding apparatus comprising:
a bit string receiver which receives bit strings about residual coefficients obtained by frequency converting a residual image;
a least significant bit extractor which extracts at least one lower bit, comprising the least significant bit from a bit string about residual coefficients having nonzero levels, from among the received bit strings; and
a bit shifter which bit-shifts the bit string about residual coefficients having nonzero levels to the left by the number of the at least one lower bit.

24. The entropy decoding apparatus of claim 23, further comprising:
a coefficient sign bit extractor which extracts a coefficient sign bit, indicating a sign of a level of a residual coefficient, from the received bit strings; and
a residual coefficient determiner which adds 1 to the bit-shifted bit string, and determines the residual coefficients based on the coefficient sign bit.

25. The entropy decoding apparatus of claim 23, wherein the bit string receiver extracts a significant coefficient bit from the received bit strings, and determines whether a level of a current residual coefficient is 0 based on the significant coefficient bit, and
when it is determined that the level of the current residual coefficient is not 0, extracts a significant coefficient remaining bit from the received bit strings, and determines whether a residual coefficient having a nonzero level exists among residual coefficients at a scan location after that of the current residual coefficient, based on the significant coefficient remaining bit.

26. The entropy decoding apparatus of claim 23, wherein the bit string receiver, when the residual coefficients are classified in a block unit comprising a predetermined number of residual coefficients, extracts a significant coefficient bit, indicating whether the block comprises a residual coefficient having a nonzero level, from the received bit strings.

27. The entropy decoding apparatus of claim 23, wherein the received bit string is expressed in a truncated unary code.

28. The entropy decoding apparatus of claim 23, wherein the received bit string is expressed in an unsigned Exponential Golomb code 0.

29. A computer readable recording medium having recorded thereon a program for executing the entropy encoding method of claim 1.

30. A computer readable recording medium having recorded thereon a program for executing the entropy decoding method of claim 9.
